(19) United States
(12) Patent Application Publication
(10) Pub. No.: US 2008/0194290 A1
(43) Pub. Date: Aug. 14, 2008

(54) Portable Electronic Device Having A Rotary Camera Unit

(75) Inventors: Philippe Lebert, Le Mans (FR); Cyrille Davoine, Le Mans (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS , N.V., Eindhoven (NL)

(21) Appl. No.: 11/909,631

(22) PCT Filed: Mar. 22, 2006
(86) PCT No.: PCT/IB2006/050875

§ 371 Date: Sep. 25, 2007

(30) Foreign Application Priority Data
Mar. 30, 2005 (EP) 05300227.5

(51) Int. Cl. H04M 1/00; H04N 5/225

(52) U.S. Cl. 455/556.1; 348/374

(57) ABSTRACT

The present invention relates to a portable electronic device comprising:
a housing;
a camera unit, which can be rotated relative to the housing, for capturing an image;
magnetic detection means for detecting a rotational position of the camera unit;
image processing means for modifying the image captured by the camera unit depending on the rotational position detected by the magnetic means.
   The magnetic detection means comprise a magnetic transmitter attached to the camera unit and a magnetic receiver attached to the housing.

### FIELD OF THE INVENTION

This invention relates generally to a portable electronic device and, more particularly, to a portable electronic device with a rotary camera unit for capturing images.

### BACKGROUND OF THE INVENTION

European patent application EP1383324 discloses a portable electronic device in the form of a mobile phone which includes a display for displaying an image, and a camera unit supported by a bearing and a hinge module for forward and reverse rotation so as to be able to take pictures of images, which can be displayed on the display, from a front side to a rear side of the display. The mobile phone comprises a reflector which is rotated in accordance with the rotation of the camera unit and has a plurality of areas of different reflection factors arranged along its circumferential direction. For determination of a control mode, a reflective photo-sensor optically detects the rotational position of the camera by projecting a beam of light toward the reflector and by receiving the light reflected from the reflector.

Thus, the position of the camera unit is determined using optical detection means. Such a portable electronic device requires a perfect sealing so as to avoid reception of parasitic light sources but also dust that could tamper the detection of the rotational position of the camera unit. The implementation of such a protection sealing is therefore complex and particularly costly.

### SUMMARY OF THE INVENTION

It is an object of the invention to propose a portable electronic device comprising a rotary camera unit and means for detecting the rotational position of the camera unit, which are cost-effective and easier to implement than the solution of the prior art.

To this end, the portable electronic device in accordance with the invention is characterized in that it comprises:

a housing;

a camera unit, which can be rotated relative to the housing, for capturing an image;

magnetic detection means for detecting a rotational position of the camera unit;

image processing means for modifying the image captured by the camera unit depending on the rotational position detected by the magnetic detection means.

As a consequence, the optical means of the prior art have been replaced by magnetic detection means. Said magnetic detection means are particularly cost-effective and easy to implement since they are not sensitive to dust or other parasitic features and therefore do not require to be sealed.

According to an exemplary embodiment of the invention, the magnetic detection means comprise a magnetic transmitter attached to the camera unit and a magnetic receiver attached to the housing. The magnetic transmitter may be a magnet. The magnetic receiver may be a Hall effect sensor.

According to another exemplary embodiment of the invention, the portable electronic device comprises a crown gear fixed to the camera unit and a flexible plate fixed to the housing, the crown gear and the flexible plate being coupled to each other.

Still according to another exemplary embodiment of the invention, the portable electronic device further comprises a display, the camera unit comprises a camera lens, the magnetic detection means are able to detect a predetermined rotational position of the camera unit where the display and the camera lens are on opposite sides of the housing, and the image processing means are adapted to reverse the image captured by the camera unit if said camera unit is in said predetermined rotational position.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 shows a portable electronic device according to an exemplary embodiment of the present invention;

FIG. 2 illustrates the use of the portable electronic device in a first operation mode;

FIG. 3 illustrates the use of the portable electronic device in a second operation mode;

FIG. 4 shows a perspective view of the camera unit and the magnetic detection means according to an exemplary embodiment of the present invention;

FIG. 5 shows an exploded view of the camera unit and the magnetic detection means according to the same exemplary embodiment of the present invention; and

FIG. 6 and FIG. 7 are cross-section views illustrating the operation of the magnetic detection means in order to detect the rotational position of the camera unit.

### DETAILED DESCRIPTION OF THE INVENTION

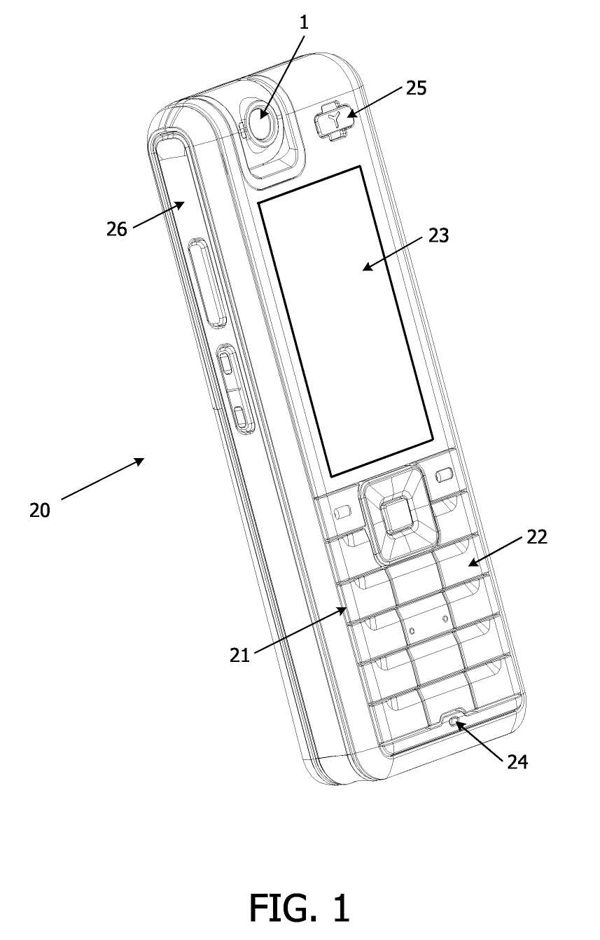

Referring to FIG. 1 of the drawings, a portable electronic device 20 according to an exemplary embodiment of the present invention is depicted. This portable electronic device is either a cordless phone or a mobile phone. It may also be a personal digital assistant (PDA) or even a camera. The portable electronic device comprises a housing 26 including a key entry section 21 which comprises a number of button switches 22 for dial entry and other functions. A display unit 23 is disposed above the key entry section 21. A microphone 24 and a loudspeaker 25, located at opposite ends of the portable electronic device 20, are provided for receiving audio signals from the surrounding area and transmitting audio signal coming from the telecommunications network, respectively.

A camera unit 1, the outer lens of which is visible, is incorporated into the portable electronic device 20, above the display unit 23. This camera unit is capable of capturing a first picture showing information about the callee, for example his face. This camera unit is also capable of capturing a second picture showing information about the caller, for example his face, so that the caller can control the information he sends to the callee. The display unit 23 may comprise two different frames, a first frame of great size showing the first picture and a second frame having a reduced size and showing the second picture.

In order to achieve such a video transmission/reception, the portable electronic device 20 comprises audio and video codecs, i.e. encoders and decoders (not represented). As an example, the video codec is based on the MPEG4 or the H.263 video encoding/decoding standard. Similarly, the audio codec is based, for example, on the MPEG-AAC or G.729 audio encoding/decoding standard.

The camera unit 1 is rotary mounted relative to the housing 26 of the portable electronic device 20.

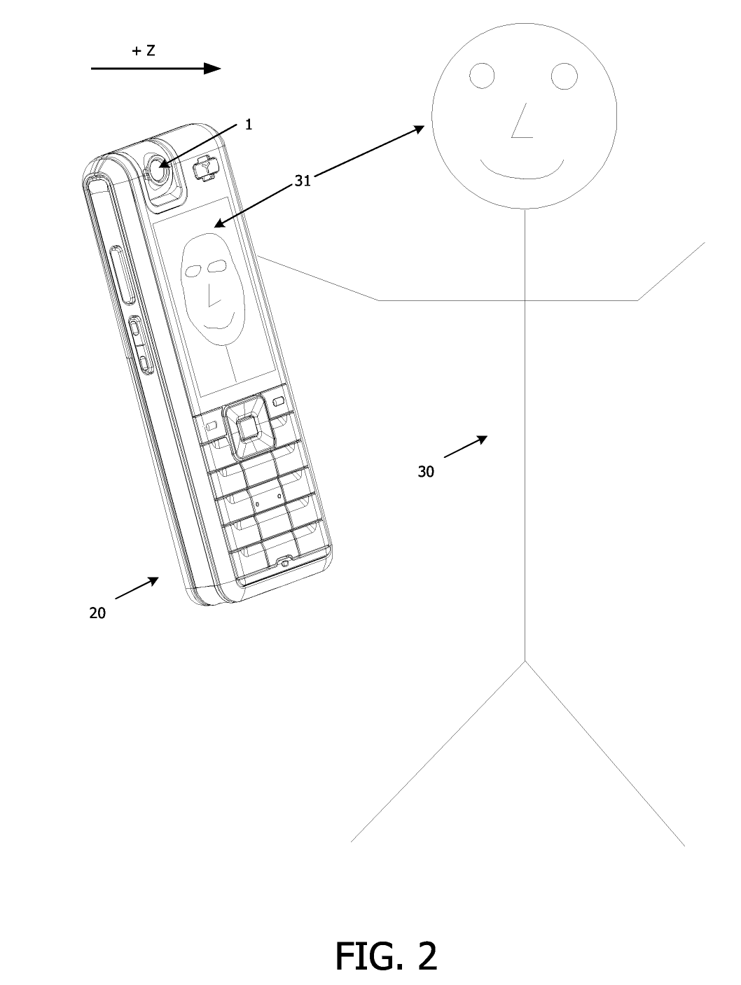

According to a first position of the camera unit 1 shown in FIG. 2, where the camera lens is on the same side of the housing as the display unit 23 (i.e. the camera lens is orientated in the +Z direction), the camera unit is able to capture a picture showing for example the face 31 of the callee 30. This capture mode is also referred to as self-portrait mode. The portable electronic device 20 is then able to display the captured picture.

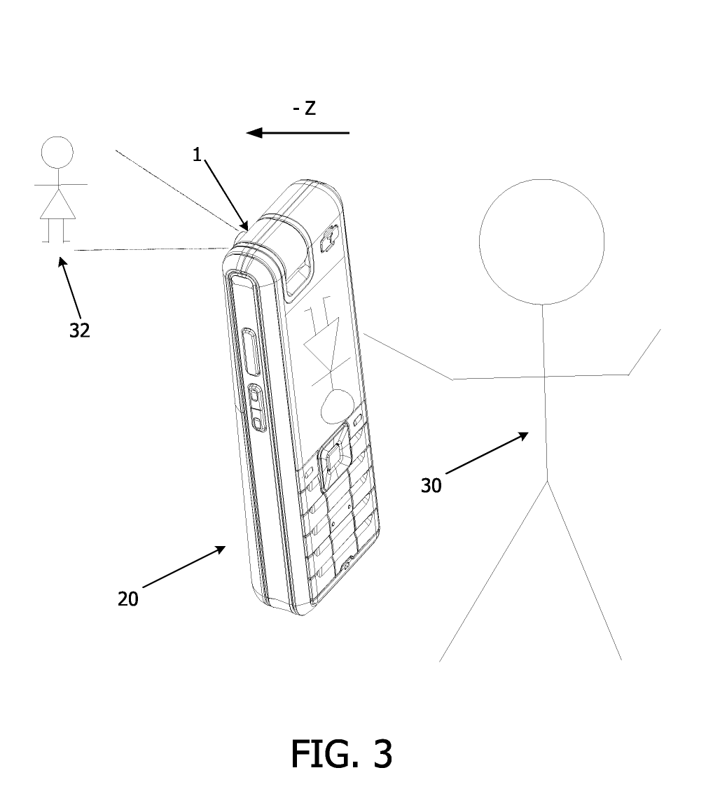

According to a second position of the camera unit 1 shown in FIG. 3, where the camera lens is on a side of the housing opposite to the side of the display unit 23 (i.e. the camera lens is orientated in the −Z direction), said camera unit is able to capture a picture showing a third party 32 in the vicinity of the callee 30. This capture mode is also referred to as camcorder mode. The portable electronic device is then able to display the captured picture. As shown in FIG. 3, if no image processing is performed on the captured image, said image of the third party 32 is reversed on the display unit, i.e. the person is displayed from bottom to top instead of top to bottom, which does not correspond to reality. That is why the portable electronic device in accordance with the invention comprises conventional image processing means (not represented) for reversing the picture so that a picture in accordance with reality is displayed. Such image processing means are adapted to reverse the captured image depending on the position of the camera unit, namely when the camera lens is orientated in the −Z direction. To this end, the portable electronic device in accordance with the invention comprises detection means for detecting the position of the camera unit.

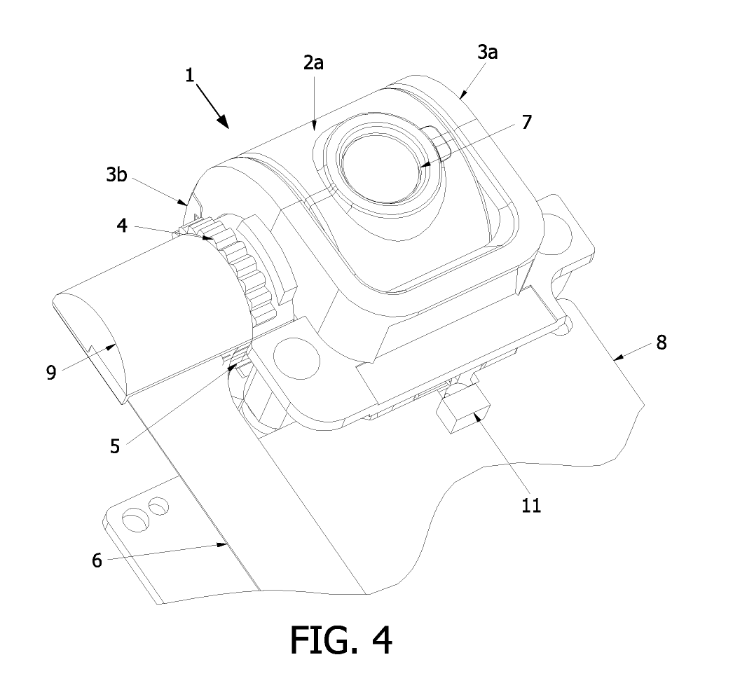

Referring to FIG. 4, the detection means are described in more detail. The camera unit 1 comprises a first 2a and a second 2b half-shells surrounding the camera lens 7. This camera unit 1 is inserted between two half-bearings 3a and 3b, said half-bearing being coupled to each other in such a way the camera unit is able to rotate therein. The half-bearings 3a and 3b are fixed to the housing of the portable electronic device 20.

The camera unit may be rotated manually. To this end, a crown gear 4 fixed to the camera unit 1 is coupled to a flexible plate 5 fixed to the housing. The coupling between the crown gear 4 and the flexible plate 5 is such that, when the camera unit rotates, the gear teeth of the crown gear 4 press against the flexible plate 5, and when the rotation is stopped, the flexible plate 5 rests between two gear teeth. The position and number of gear teeth depend on the elementary rotation to be achieved. As an example, the gear teeth are dimensioned so as to achieve a rotation of 15 degrees per gear tooth and the crown gear 4 comprises 19 gear teeth so as to achieve a maximum rotation of 270 degrees.

A ribbon cable 6 coupled to the camera unit 1 permits the transmission of the video data captured by the camera unit, said cable being connected to a connector fixed on a printed-circuit board (PCB) 8 attached to the housing. The ribbon cable 6 can be wrapped and unwrapped around a foil support 9, which is fixed to the crown gear 4 so that the foil support 9, the crown gear 4 and the camera unit 1 rotates at the same time. A Hall effect sensor 11 is fixed to the PCB 8.

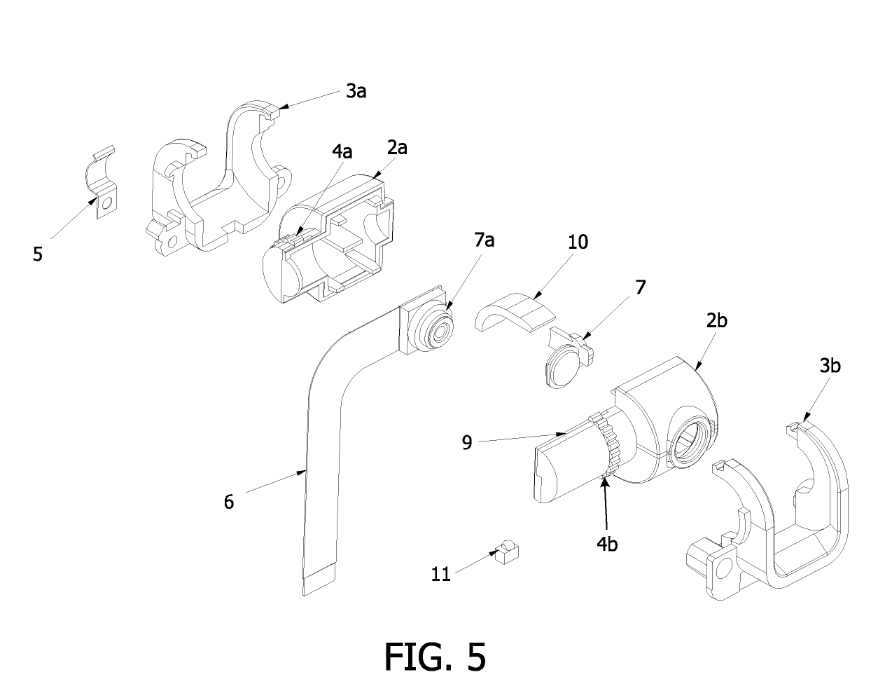

Turning now to FIG. 5, an exploded view of the camera unit and detections means is given. The two half-bearings 3a and 3b surrounding the camera unit can be seen on each side of the exploded view, the flexible plate 5 being fixed to the half-bearing 3a. Then, the first 2a and second 2b half-shells forming the camera unit are shown. According to the exemplary embodiment of the invention illustrated in this exploded view, the half shell 2b, the half crown gear 4b and the foil support 9 are made of one piece of material. Similarly, the half shell 2a and a half crown gear 4a are also made of one piece of material. However, it will be apparent to a skilled person that alternative are possible, e.g. the foil support 9 and the crown gear 4 may be separate parts that are fixed to the assembly of the two half-shells 2a and 2b. The camera unit also comprises the camera lens 7 and a camera sensor 7a (e.g. CMOS or CCD) which is connected to the ribbon cable 6.

FIG. 5 also shows a magnet 10 which is attached to one of the half-shell 2a or 2b so that the magnet and camera unit rotates at the same time. The Hall effect sensor 11, which is attached to the housing, together with the magnet 10, which is attached to the camera unit, form the detection means.

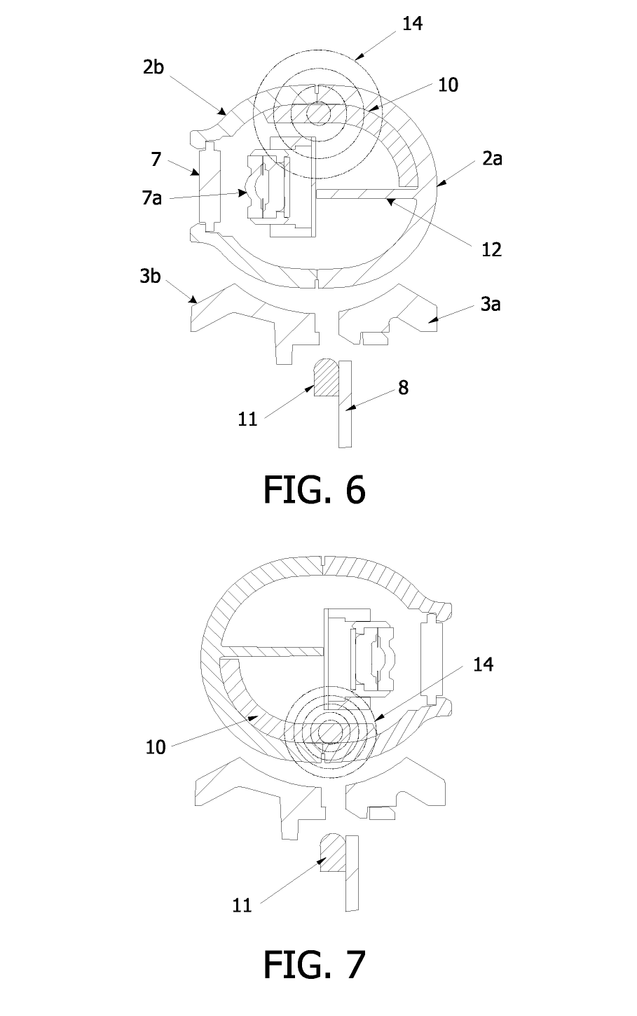

FIG. 6 and FIG. 7 illustrate the operation of the magnetic detection means in order to detect the rotational position of the camera unit. According to these Figures, the magnet 10 is fixed to the half-shell 2A using a rib 12 which is part of the first half-shell 2a.

According to FIG. 6, when the camera unit is in the camcorder mode, as shown in FIG. 3, the magnet 10 is in the far field of the Hall effect sensor 11 so that said sensor receives a minimum magnetic field 14 and outputs a minimum voltage.

According to FIG. 7, when the camera unit is in the self-portrait mode, as shown in FIG. 2, the magnet 10 is in the near field of the Hall effect sensor 11 so that said sensor receives a maximum magnetic field 14 and outputs a maximum voltage.

Thus, when the camera unit is in an intermediary position between the two above-described positions, where the rib 12 is substantially aligned with the PCB 8, the Hall effect sensor 11 receives a medium magnetic field 14 and outputs a medium voltage. As a consequence, if the voltage output by the Hall effect sensor is higher than this medium voltage, then the camera unit is in the self-portrait mode and the image is not reversed. On the contrary, if the voltage output by the Hall effect sensor is lower than the medium voltage, then the camera unit is in the camcorder mode and the image is reversed using the image processing means.

The operation of the magnetic detection means is depicted in the context of FIGS. 6 and 7 but it will be apparent to a skilled person that the invention is not restricted to this particular position of the magnet 10. The invention may be applicable to other configurations of the magnetic means provided that a threshold signal delivered by a magnetic receiver (e.g. the Hall effect sensor 11) is determined for a threshold rotational position of the camera unit corresponding to a switch between a first camera mode to a second camera mode, the image processing means being then adapted to modify an image captured by the camera unit for a given rotational position (corresponding to the first or second camera mode) of the camera unit depending on a comparison of the value of the signal delivered by the magnetic receiver for said given rotational position with the threshold value.

It is also to be noted that the invention is neither limited by the number of available camera modes which can be more than two, nor limited by the processing function implemented by the image processing means which can be other geometric transformations, for example rotation or translation, than the reversing function.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A portable electronic device (20) comprising:
a housing (26);
a camera unit (1), which can be rotated relative to the housing, for capturing an image;
magnetic detection means for detecting a rotational position of the camera unit, said magnetic detection means comprising a magnetic transmitter (10) attached to the camera unit and a magnetic receiver (11) attached to the housing;
image processing means for modifying the image captured by the camera unit depending on the rotational position detected by the magnetic means;
characterized that the camera unit comprises two half-shelves (2a,2b) and in that the magnetic transmitter (10) is fixed to one of the half-shelves.

2. A portable electronic device as claimed in claim 1, wherein the magnetic transmitter (10) is a magnet.

3. A portable electronic device as claimed in claim 1, wherein the magnetic receiver (11) is a Hall effect sensor.

4. A portable electronic device as claimed in claim 1, further comprising a crown gear (4) fixed to the camera unit (1) and a flexible plate (5) fixed to the housing, the crown gear (4) and the flexible plate (5) being coupled to each other.

5. A portable electronic device (20) as claimed in claim 1 further comprising a display (23), wherein the camera unit (1) comprises a camera lens (7), wherein the magnetic detection means are able to detect a predetermined rotational position of the camera unit where the display and the camera lens are on opposite sides of the housing (26), and wherein the image processing means are adapted to reverse the image captured by the camera unit if said camera unit is in said predetermined rotational position.

6. A portable electronic device as claimed in claim 1, wherein the device is a cordless phone.

7. A portable electronic device as claimed in claim 1, wherein the device is a mobile phone.
